(19) United States
(12) Patent Application Publication
(10) Pub. No.: US 2026/0062288 A1
(43) Pub. Date: Mar. 5, 2026

(54) REACTOR SYSTEMS AND PROCESSES FOR LIGHT HYDROCARBON CATALYTIC CRACKING TO PRODUCE HIGH VALUE HYDROGEN AND SOLID CARBON

(71) Applicant: Chevron U.S.A. Inc., San Ramon, CA (US)

(72) Inventors: Huping Luo, Moraga, CA (US); Xiaoying Ouyang, Albany, CA (US); Christopher Declan Lane, Kensington, CA (US); Howard Steven Lacheen, Richmond, CA (US); Steven Brogden, Carmel Valley, CA (US); Yaofan Yi, Moraga, CA (US)

(21) Appl. No.: 18/936,144

(22) Filed: Nov. 4, 2024

Related U.S. Application Data
(60) Provisional application No. 63/688,721, filed on Aug. 29, 2024.

(51) Int. Cl. C01B 3/30; B01D 53/047; B01D 53/14; B01D 53/22; B01J 8/00; B01J 8/18; B01J 38/60; B01J 38/68; C01B 3/50; C01B 3/52; C01B 3/56; C01B 32/05

(52) U.S. Cl. CPC C01B 3/28; B01D 53/047; B01D 53/1475; B01D 53/229; B01J 8/005; B01J 8/1827; B01J 8/1836; B01J 38/60; B01J 38/68; C01B 3/501; C01B 3/52; C01B 3/56; C01B 32/05; B01D 2257/108; B01D 2257/502; B01D 2257/504; B01D 2257/702; B01D 2257/80; B01J 2208/00176; B01J 2208/00761; C01B 2203/0277; C01B 2203/0405; C01B 2203/0415; C01B 2203/042; C01B 2203/048; C01B 2203/049; C01B 2203/0833; C01B 2203/1082; C01B 2203/1241; C01P 2006/80

(57) ABSTRACT

A process for producing high purity hydrogen includes separating a gas stream comprising hydrogen and unreacted light hydrocarbons from a product effluent comprising the gas stream comprising the hydrogen and the unreacted light hydrocarbons, and a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor, separating the hydrogen and the unreacted light hydrocarbons from the gas stream comprising the hydrogen and the unreacted light hydrocarbons, and withdrawing high purity hydrogen.

### PRIORITY CLAIM

The present application claims priority to U.S. Provisional Patent Application Ser. No. 63/688,721, entitled “Reactor Systems and Processes for Light Hydrocarbon Catalytic Cracking to Produce High Value Hydrogen and Solid Carbon,” filed Aug. 29, 2024, the content of which is incorporated by reference herein in its entirety.

### BACKGROUND

Catalytic cracking of light hydrocarbons such as, for example, methane, ethane, natural gas, etc., can produce “turquois” hydrogen and solid carbon with significantly lower carbon emissions than current technologies, such as steam methane reforming (SMR) with or without carbon capture sequestration (CCS). Leveraging today's natural gas assets and distribution infrastructure, natural gas catalytic cracking allows for producing scalable, affordable and cleaner hydrogen at a production site or at a customer site near liquefied natural gas (LNG) receiving terminals to supply affordable hydrogen with significantly reduced transportation cost.

### SUMMARY

In accordance with an illustrative embodiment, a process for producing high purity hydrogen comprises:
separating a gas stream comprising hydrogen and unreacted light hydrocarbons from a product effluent comprising the gas stream comprising the hydrogen and the unreacted light hydrocarbons, and a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor,
separating the hydrogen and the unreacted light hydrocarbons from the gas stream comprising the hydrogen and the unreacted light hydrocarbons, and
withdrawing high purity hydrogen.

In accordance with another illustrative embodiment, a reactor system comprises:
a reactor configured to catalytically crack a light hydrocarbon feed stream in the presence of a carbon supported metal catalyst comprising one or more active metal compounds to generate a product effluent comprising (i) a gas stream comprising hydrogen and unreacted light hydrocarbons and (ii) a spent carbon supported metal catalyst comprising one or more active metal compounds and solid carbon deposits,
a first separation unit configured to separate the gas stream comprising the hydrogen and the unreacted light hydrocarbons from the product effluent, and
a second separation unit configured to separate the hydrogen and the unreacted light hydrocarbons from the gas stream to generate high purity hydrogen and a recycle stream comprising the unreacted light hydrocarbons.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternate processes and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1A illustrates a reactor system using a fluidized bed reactor, a product effluent separation system, an acid leaching system and a catalyst synthesis system, according to an illustrative embodiment.

FIG. 1B illustrates a reactor system using a fluidized bed reactor, a product effluent separation system, an acid leaching system and a catalyst synthesis system, according to an alternative illustrative embodiment.

FIG. 2 illustrates a reactor system using a sprouted bed reactor, a product effluent separation system, an acid leaching system and a catalyst synthesis system, according to an illustrative embodiment.

### DETAILED DESCRIPTION

Various illustrative embodiments described herein are directed to reactor systems and processes for producing high purity hydrogen from a product effluent comprising (i) a gas stream comprising hydrogen and unreacted light hydrocarbons and (ii) a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor, as well as producing a high purity solid carbon product from the product effluent comprising (i) a gas stream comprising hydrogen and unreacted light hydrocarbons and (ii) the spent carbon supported metal catalyst comprising the one or more active metal compounds and the solid carbon deposits. The conversion of light hydrocarbons into added value chemicals, materials and fuels offers one alternative to crude.

Direct conversion of light hydrocarbons such as, for example, methane, ethane, natural gas, etc., by catalytic cracking can produce hydrogen along with solid carbon as a by-product without producing carbon dioxide (CO₂) and hence with much lower carbon intensity than current technologies, such as steam methane reforming (SMR) with or without carbon capture sequestration (CCS). The process development of the catalytic cracking of light hydrocarbon however is still in its early stage, albeit rapidly gaining momentum due to increased efforts from industrial and academic sources. However, the reactor design and associated engineering difficulties are known to be the main hurdles to develop a cost-effective process for producing high quality hydrogen and high value carbon products.

In view of these challenges, there is a need for solutions that produce high quality hydrogen and value-added solid carbon from light hydrocarbons in a cost-effective manner. In addition, it would be advantageous for the reactor design for this process to have the capability to (1) provide the reaction heat needed to maintain an optimized temperature profile to achieve high conversion, (2) utilize a product effluent separation system to remove remaining solid carbon and gaseous impurities before separating out and recycling unreacted light hydrocarbon such as methane to produce a higher purity hydrogen product, and (3) utilize an acid leaching and catalyst synthesis system to remove metals from a portion of the produced solid carbon via acid leaching to produce a high purity solid carbon product while using solid carbon from spent catalyst and recovered metal along with make-up metal compounds to synthesis fresh catalysts for sending to the reactor system to maintain high catalytic activity in the reactor.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated carbon supported metal catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated carbon supported metal catalyst typically has an activity that is equal to or less than the fresh catalyst activity.

The term “zone” can refer to an area including one or more equipment items and/or one or more sub-zones. Equipment items can include one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The terms “separation unit” and “separator” refer to any separation device(s) that at least partially separates one or more chemical constituents in a mixture from one another. For example, a separation system may selectively separate different chemical constituents from one another, forming one or more chemical fractions. Examples of separation systems include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, or combinations or these. The separation processes described in the present disclosure may not completely separate all of one chemical constituent from all of another chemical constituent. Instead, the separation processes described in the present disclosure “at least partially” separate different chemical constituents from one another and, even if not explicitly stated, separation may include only partial separation.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

The term “primarily” shall be understood to mean an amount greater than 50%, e.g., 50.01 to 100%, or any range between, e.g., 51 to 95%, 75% to 90%, at least 60%, at least 70%, at least 80%, etc.

The non-limiting illustrative embodiments described herein overcome the foregoing drawbacks by providing reactor systems and processes for producing high purity hydrogen from a product effluent comprising (i) a gas stream comprising hydrogen and unreacted light hydrocarbons and (ii) a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor, as well as producing a high purity solid carbon product from the product effluent.

In some embodiments, the processes described herein utilize a reactor system including a reactor to carry out highly endothermic light hydrocarbon catalytic cracking reactions using suitable carbon supported metal catalysts under reaction conditions to produce a product effluent comprising (i) a gas stream comprising hydrogen and unreacted light hydrocarbons and (ii) a spent carbon supported metal catalyst comprising one or more active metal compounds and solid carbon deposits, and a heat integration system to provide the heat required to keep the reactor at a desired reaction temperature.

In some embodiments, the reactor includes, for example, fluidized bed reactors, sprouted bed reactors, fixed bed reactors or radial flow reactors. In some embodiments, the light hydrocarbon feed is preheated to a desirable temperature before being injected in the reactor where it contacts with carbon supported metal catalysts for the light hydrocarbon catalytic cracking reaction, which produces a product effluent comprising (i) a gas stream comprising hydrogen and unreacted light hydrocarbons and (ii) a spent carbon supported metal catalyst comprising one or more active metal compounds and solid carbon deposits exiting the reactor such as from the top of the reactor.

In some embodiments, the processes described herein utilize a reactor system further including a product effluent separation system to remove the spent carbon supported metal catalyst and gaseous impurities, such as one or more of carbon monoxide, carbon dioxide and water from a product effluent comprising (i) a gas stream comprising hydrogen and unreacted light hydrocarbons and (ii) the spent carbon supported metal catalyst comprising the one or more active metal compounds and the solid carbon deposits before separating out and recycling the unreacted light hydrocarbon such as methane to produce a high purity hydrogen product.

In some embodiments, the processes described herein utilize a reactor system further including an acid leaching system to solubilize metals from the spent carbon supported metal catalyst comprising one or more active metals and solid carbon deposits via acid leaching to produce a high purity solid carbon product, and a catalyst synthesis system to use the solubilized metals from the acid leaching system with additional spent carbon supported metal catalyst along with make-up metal compounds to synthesize fresh carbon supported metal catalysts for feeding to the reactor of the reactor system to maintain high catalytic activity in the reactor.

### Light Hydrocarbon Feed Stream

The light hydrocarbon feed stream to be employed is not particularly limited and may include, for example, C₁ to C₆ or C₁ to C₄ or C₁ to C₃ or C₁ to C₂ alkanes such as methane, ethane, or natural gas either pure or in any suitable mixture. In some embodiments, the light hydrocarbon feed stream may also contain minor amounts of other ingredients including, for example, carbon dioxide, sulfur compounds such as H₂S, water, nitrogen, and mixtures thereof. In some embodiments the light hydrocarbon feed stream may also include steam, superheated steam, an inert gas such as nitrogen, or any mixture thereof. In some embodiments, the light hydrocarbon feed stream to be employed may include any suitable composition such that the resulting product includes at least hydrogen.

In some embodiments, the light hydrocarbon feed stream comprises methane or natural gas such as, for example, a light hydrocarbon feed stream comprising greater than about 80%, or greater than about 90%, or greater than about 95%, or greater than about 99% methane. As used herein, natural gas comprises methane and potentially higher alkanes, carbon dioxide, nitrogen or other gases, and/or sulfide compounds such as hydrogen sulfide, and mixtures thereof. In illustrative embodiments, the light hydrocarbon feed stream may further contain a portion of the produced products that are recycled back to the light hydrocarbon feed stream such as unreacted methane.

### Catalyst

In an illustrative embodiment, as may be combined with one or more of the preceding paragraphs, the particulate carbon supported metal catalyst for the light hydrocarbon catalytic cracking process described herein can be a highly porous carbon support containing one or more active metal compounds. Suitable highly porous carbon supports include, for example, activated carbon, carbon nanotube, carbon fiber, etc. In some embodiments, an active catalytical metal for the highly porous carbon supports include highly dispersed metal compounds impregnated on the carbon support. In some embodiments, an active metal includes, for example, Ni, Fe, Cu, Tb, Zn, Co, Pd, Sn, etc. In an illustrative embodiment, the metal can be present in an amount ranging from about 0.01 wt. % to about 50 wt. %.

The carbon supported metal catalyst may be in any of the commonly used catalyst shapes such as, for example, spheres, granules, pellets, chips, rings, extrudates, or powders that are well-known in the art.

In an illustrative embodiment, as may be combined with one or more of the preceding paragraphs, the active catalytical metal can be in particle form have a particle size of from about 1 nanometer (nm) to about 100 nm. In some embodiments, the active catalytical metal can be in particle form having a particle size of from about 1 nm to about 50 nm. In some embodiments, the active catalytical metal can be in particle form having a particle size of from about 1 nm to about 20 nm.

### Product Effluent

The product effluent derived from cracking the light hydrocarbon feed stream typically comprises (i) a gas stream including hydrogen, a C₂ to C₁₀ hydrocarbon product, and unreacted light hydrocarbons, and (ii) a spent carbon supported metal catalyst comprising one or more active metal compounds and solid carbon deposits. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid hydrocarbon product, a gaseous hydrocarbon product, a solid hydrocarbon product and combinations thereof depending on the particular methane conversion process.

Suitable reaction conditions may vary depending upon the reactants, desired products, catalysts, and equipment employed. In illustrative embodiments, a suitable temperature for cracking a heated light hydrocarbon feed stream in the reactor to produce the product effluent can be from about 500° C., or from about 700° C., and up to about 1000° C. or up to about 1200° C. In some embodiments, the cracking can take place at a pressure of from about 1 atmosphere up to about 3 atmospheres, or up to about 5 atmospheres, or up to about 10 atmospheres.

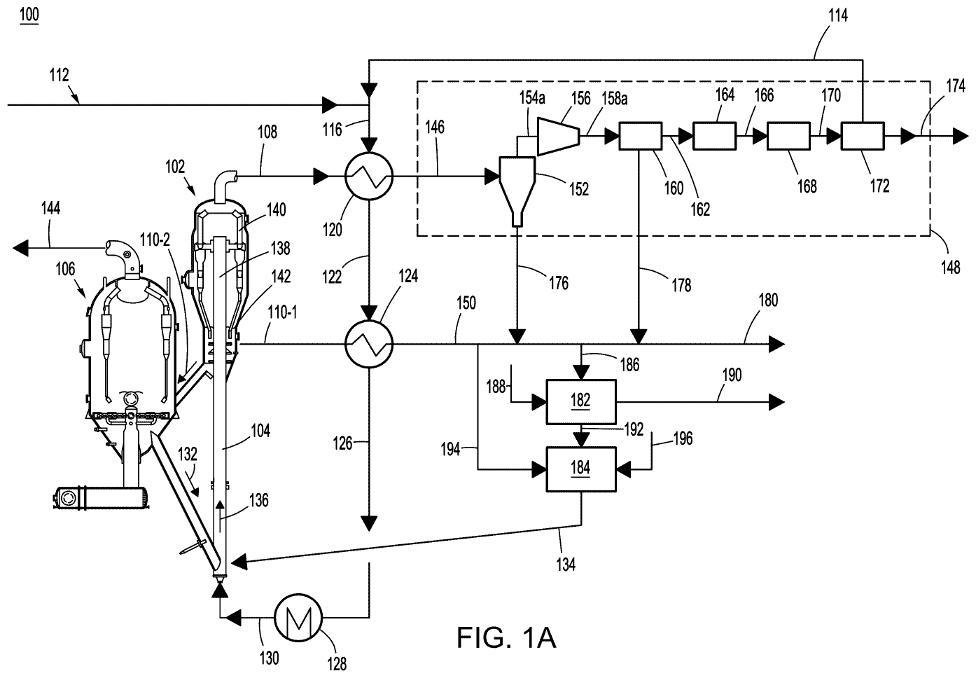

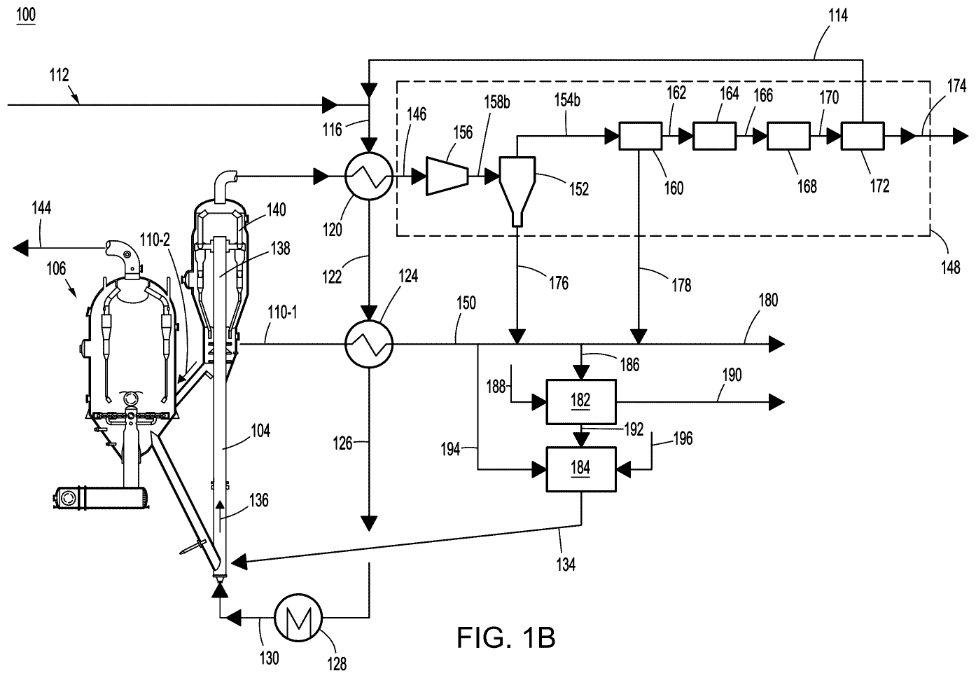

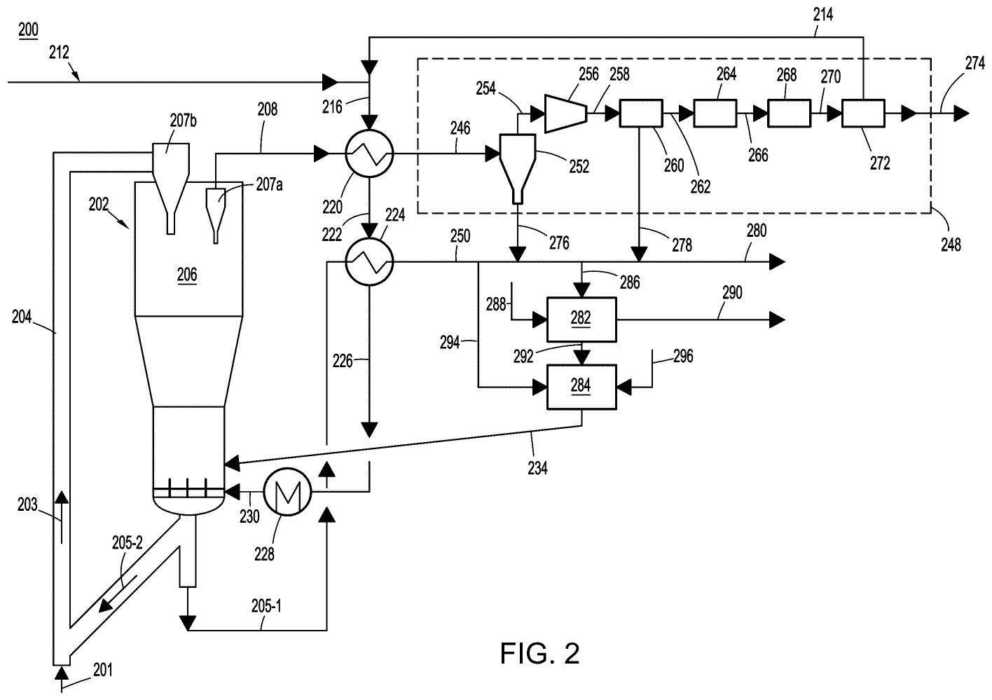

The non-limiting illustrative embodiments of the present disclosure will be specifically described below with reference to the accompanying drawings. For the purpose of clarity, some steps leading up to the production of the product effluent comprising (i) a gas stream comprising hydrogen and unreacted light hydrocarbons and (ii) a spent carbon supported metal catalyst comprising one or more active metal compounds and solid carbon deposits, and the production of high purity hydrogen and a high purity solid carbon product as illustrated in FIGS. 1A to 2 may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

### Reactor Systems

Referring now to the drawings in more detail, FIGS. 1A to 2 illustrate a reactor system including at least a reactor, a product effluent separation system, an acid leaching system and a catalyst synthesis system. It is to be understood that the reactor system including at least the reactor, the product effluent separation system, the acid leaching system and the catalyst synthesis system are not limited to the configuration of the embodiments shown in FIGS. 1A to 2, and other configurations are contemplated herein.

The non-limiting illustrative embodiments of FIGS. 1A and 1B will now be described in more detail.

### Fluidized Bed Reactor

Referring now to the drawings in more detail, FIGS. 1A and 1B illustrate a reactor system 100 utilizing a fluidized bed reactor 102, a riser 104 and a catalyst regeneration unit 106 for producing a product effluent comprising a gas stream comprising hydrogen and unreacted light hydrocarbons, and a spent carbon supported metal catalyst comprising one or more active metal compounds and solid carbon deposits. In some embodiments, the product effluent further includes acid gases such as carbon monoxide, carbon dioxide and water. It is to be understood that reactor system 100 including at least fluidized bed reactor 102, riser 104 and catalyst regeneration unit 106 is not limited to the configuration of the embodiments shown in FIGS. 1A and 1B, and other configurations are contemplated herein. In some embodiments, each of fluidized bed reactor 102, riser 104 and catalyst regeneration unit 106 can have an interior wall formed from a reactor lining having one or more layers of a refractory material to reduce heat loss and sustain the high temperatures in reactor system 100.

In operation, riser 104 receives a third heated light hydrocarbon feed stream 130 through an inlet in a bottom portion of riser 104. In some embodiments, third heated light hydrocarbon feed stream 130 enters riser 104 at a temperature ranging from about 500° C. to about 1200° C. Third heated light hydrocarbon feed stream 130 is combined with a regenerated carbon supported metal catalyst stream 132 and a fresh carbon supported metal catalyst stream 134 as discussed below to form a regenerated carbon supported metal catalyst and light hydrocarbon stream 136 which flows upward in riser 104 utilizing, for example, a flow distributor or a fluidization ring (not shown). The flow of regenerated carbon supported metal catalyst stream 132 can be controlled, for example, by valve. In a non-limiting illustrative embodiment, riser 104 may have a cylindrical configuration with a constant diameter along all or a portion of its length. In some embodiments, riser 104 may have a cylindrical configuration from a top of riser 104 to a bottom of riser 104 with a uniform diameter. However, as one skilled in the art will appreciate, the cylindrical configurations are merely illustrative and any other suitable shape of the same or varying diameters are contemplated herein.

Regenerated carbon supported metal catalyst and light hydrocarbon stream 136 flows upwards to a reaction chamber 138 of riser 104 at a sufficient temperature to crack the light hydrocarbon feed stream, i.e., a temperature ranging from about 500° C. to about 1200° C., to produce the product effluent comprising a gas stream comprising hydrogen and unreacted light hydrocarbons, and a spent carbon supported metal catalyst comprising one or more active metal compounds and solid carbon deposits. In some embodiments, regenerated carbon supported metal catalyst stream 132 enters riser 104 at a temperature sufficient to further heat third heated light hydrocarbon feed stream 130 to a desired reaction temperature in fluidized bed reactor 102. For example, in some embodiments, regenerated carbon supported metal catalyst stream 132 enters riser 104 at a temperature ranging from about 500° C. to about 1200° C. In some embodiments, when regenerated carbon supported metal catalyst stream 132 enters riser 104 at a temperature that is not sufficient for maintaining a desired reaction temperature in fluidized bed reactor 102, a furnace or a fired heat exchanger (not shown) can be used to provide sufficient heat to fluidized bed reactor 102 to maintain a desirable reaction temperature. In some embodiments, a fuel being supplied to the furnace or heat exchanger can be a tail gas stream from a downstream separation system. In some embodiments, an electric heater (not shown) can be embedded inside fluidized bed reactor 102 for maintaining a desired reaction temperature in fluidized bed reactor 102. In one embodiment, the electricity supplied to the electric heater can be from a renewable source or from an intermittent source such as solar power (including photovoltaic and reflective), wind power, tidal power, wave power, batteries, and other intermittent energy sources known in the art and combinations thereof.

Fluidized bed reactor 102 further includes separators 140 located at the top of fluidized bed reactor 102 for receiving the reaction stream comprising a gas stream comprising hydrogen and unreacted light hydrocarbons, and a spent carbon supported metal catalyst comprising one or more active metal compounds and solid carbon deposits. In some embodiments, separators 140 for use herein can include, for example, a cyclone. Although two separators are shown for separators 140 in FIGS. 1A and 1B, the number of separators is merely illustrative and any number higher or lower can be used in fluidized bed reactor 102 based on such factors as, for example, reactor design, etc.

As one skilled in the art will readily appreciate, the spent carbon supported metal catalyst can be of varying particle sizes. Accordingly, when the reaction stream is passed through separators 140, a first portion of the spent carbon supported metal catalyst having a relatively large particle size (e.g., a particle size of greater than 1 to 100 micrometers) will be separated from the reaction stream. The gas stream comprising the hydrogen and the unreacted light hydrocarbons will further include a second portion of the spent carbon supported metal catalyst having a relatively small particle size, sometimes referred to as entrained tiny solid particles, (e.g., a particle size of less than 1 to 100 micrometers). The gas stream will exit fluidized bed reactor 102 as a product effluent 108. Thus, in some embodiments, separators 140 separate a first portion of the spent carbon supported metal catalyst comprising the one or more active metal compounds and the solid carbon deposits from the product effluent to generate a product effluent 108 comprising (i) a gas stream comprising hydrogen and unreacted light hydrocarbons and (ii) a second portion of the spent carbon supported metal catalyst comprising the one or more active metal compounds and the solid carbon deposits (hereinafter referred to as the spent carbon supported metal catalyst comprising the one or more active metal compounds and the solid carbon deposits). In some embodiments, product effluent 108 further includes acid gases such as carbon monoxide, carbon dioxide and water.

The first portion of the spent carbon supported metal catalyst then flows downward from separators 140 and to a reactor stripper 142. In some embodiments, the spent carbon supported metal catalyst flows downward by, for example, gravity forces. The spent carbon supported metal catalyst can then be split into two streams, namely, a spent carbon supported metal catalyst 110-1 and a spent carbon supported metal catalyst 110-2 (collectively referred to as spent carbon supported metal catalyst 110).

Reactor system 100 further includes catalyst regeneration unit 106 for receiving spent carbon supported metal catalyst 110-2 from reactor stripper 142 which is in fluid communication with fluidized bed reactor 102 and riser 104. As discussed above, spent carbon supported metal catalyst 110 includes solid carbon deposits. In some embodiments, spent carbon supported metal catalyst 110-2 is continuously introduced to catalyst regeneration unit 106 via reactor stripper 142 where spent carbon supported metal catalyst 110-2 is subjected to solid carbon burning conditions to burn a portion of the solid carbon deposits from spent carbon supported metal catalyst 110-2 and provide a regenerated carbon supported metal catalyst stream 132. For example, in an illustrative embodiment, catalyst regeneration unit 106 can include a regeneration gas inlet adapted to receive an oxidizing stream into catalyst regeneration unit 106 (not shown). The regeneration gas inlet may be disposed at the bottom of catalyst regeneration unit 106. The oxidizing stream can enter catalyst regeneration unit 106 through a heating unit (e.g., an air or steam heater) to generate a heated oxidizing stream. The oxidizing stream can contain, for example, air, oxygen, nitrogen, methane or combinations thereof or a steam/air mixture.

Catalyst regeneration unit 106 can further include a flow distributor (not shown) which is configured to inject the heated oxidizing stream amongst spent carbon supported metal catalyst 110-2 disposed in catalyst regeneration unit 106. The solid carbon can be burned from spent carbon supported metal catalyst 110-2 by exposing spent carbon supported metal catalyst 110-2 to the heated oxidizing stream at appropriate high temperature and time duration conditions to burn off and remove a portion of the solid carbon deposits from spent carbon supported metal catalyst 110-2. In an illustrative embodiment, a temperature can range from about 450° C. to about 1400° C., and a time period can range from about 10 minutes to about 600 minutes. Accordingly, the regenerating of spent carbon supported metal catalyst 110-2 generally comprises combustion of spent carbon supported metal catalyst 110-2 in an oxidizing atmosphere to burn the solid carbon deposits and redisperse active metal on the catalyst particles. Burning the solid carbon deposits is an exothermic process that can supply the heat needed for the reaction process. In a heat balanced operation, the quantity of solid carbon deposits formed on the catalyst is significant enough that no external heat source or fuel is needed to supplement the heat from the solid carbon deposits combustion.

In some embodiments, catalyst regeneration unit 106 is operated as a moving bed with spent carbon supported metal catalyst 110-2 continuously moving downwards. In some embodiments, catalyst regeneration unit 106 is operated as a fluidized bed.

In some embodiments, the heated oxidizing stream can be used to fluidize regenerated carbon supported metal catalyst stream 132 in catalyst regeneration unit 106. Regenerated carbon supported metal catalyst stream 132 is continuously introduced to riser 104 at an elevated temperature relative to the temperature of spent carbon supported metal catalyst 110-2. The heat generated by the solid carbon deposit burn in catalyst regeneration unit 106 can be continuously transferred with regenerated carbon supported metal catalyst stream 132 to riser 104.

The solid carbon deposit burn causes spent carbon supported metal catalyst 110-2 to be heated to an elevated temperature, e.g., a temperature of from about 450° C. to about 1400° C., to provide regenerated carbon supported metal catalyst stream 132 wherein the catalyst particles are heated, and sent to riser 104. The solid carbon deposit also generates a flue gas which will pass through a series of separators (e.g., cyclones), where the solid particulates carried over in the flue gas can be separated and drained back down to the lower section of catalyst regeneration unit 106 and generate a flue gas stream 144 free of particulates exiting through a top portion of catalyst regeneration unit 106. In some embodiments, flue gas stream 144 can be composed of, for example, carbon dioxide and nitrogen.

In some embodiments, riser 104 has a first diameter and fluidized bed reactor 102 has a second diameter greater than the first diameter. In some embodiments, by riser 104 having a smaller diameter than fluidized bed reactor 102, regenerated carbon supported metal catalyst stream 132 can be substantially or fully fluidized when contacting with third heated light hydrocarbon feed stream 130 to carry out the direct light hydrocarbon conversion reactions.

In illustrative embodiments, regenerated carbon supported metal catalyst and light hydrocarbon stream 136 are subjected to reaction conditions such as, for example, a temperature of from about 500° C. to about 1200° C., and for a residence time of regenerated carbon supported metal catalyst and light hydrocarbon feed stream 136 in fluidized bed reactor 102 of from about 0.05 seconds to about 100 seconds, or from about 0.1 seconds to about 2 seconds.

Product effluent 108 comprising (i) a gas stream comprising hydrogen and unreacted light hydrocarbons and (ii) the spent carbon supported metal catalyst comprising the one or more active metal compounds and the solid carbon deposits exits fluidized bed reactor 102 at a temperature ranging from about 500° C. to about 1200° C. and enters a heat exchanger 120 to transfer heat to a light hydrocarbon feed stream 116. Light hydrocarbon feed stream 116 includes an incoming light hydrocarbon feed stream 112 and a recycled light hydrocarbon stream 114 from a hydrogen purification unit 172 as discussed below.

Heat exchanger 120 receives product effluent 108 as a heat transfer medium to generate a first heated light hydrocarbon feed stream 122 for sending to a heat exchanger 124, and a cooled product effluent 146 for sending to a product effluent separation system 148. In other words, product effluent 108 delivers the heat in heat exchanger 120 to light hydrocarbon feed stream 116 and generates first heated light hydrocarbon feed stream 122 having a temperature of from about 100° C. to about 600° C., and product effluent 108 is likewise cooled against light hydrocarbon feed stream 116 in heat exchanger 120 to generate cooled product effluent 146 having a temperature of from about 20° C. to about 300° C. In some embodiments, heat exchanger 120 may be a shell-and-tube, plate-fin, microchannel, spiral wound, or any other suitable heat exchanger.

Spent carbon supported metal catalyst 110-1 exits reactor stripper 142 at a temperature ranging from about 500° C. to about 1200° C. and enters heat exchanger 124 to transfer heat to first heated light hydrocarbon feed stream 122. In other words, spent carbon supported metal catalyst 110-1 delivers the heat in heat exchanger 124 to first heated light hydrocarbon feed stream 122 and generates a second heated light hydrocarbon feed stream 126 having a temperature of from about 300° C. to about 1000° C., and spent carbon supported metal catalyst 110-1 is likewise cooled against first heated light hydrocarbon feed stream 122 to generate a cooled spent carbon supported metal catalyst 150 having a temperature of from about 100° C. to about 500° C. In some embodiments, heat exchanger 124 may be a shell-and-tube, plate-fin, microchannel, spiral wound, or any other suitable heat exchanger.

In some embodiments, a heat exchanger 128 is utilized to further heat second heated light hydrocarbon feed stream 126, if necessary, to generate a third heated light hydrocarbon feed stream 130 for sending to fluidized bed reactor 102 as discussed above. In some embodiments, heat exchanger 128 may be a shell-and-tube, plate-fin, microchannel, spiral wound, or any other suitable heat exchanger.

### Product Effluent Separation System

Reactor system 100 further includes product effluent separation system 148 for processing cooled product effluent 146 to produce a high purity hydrogen product 174. Product effluent separation system 148 includes a separation unit 152 for receiving cooled product effluent 146 comprising (i) a gas stream comprising hydrogen and unreacted light hydrocarbons and (ii) the spent carbon supported metal catalyst comprising the one or more active metal compounds and the solid carbon deposits (see FIG. 1A). Separation unit 152 separates the spent carbon supported metal catalyst present in cooled product effluent 146 to generate a clean gas stream 154a comprising hydrogen and unreacted light hydrocarbons, and a spent carbon supported metal catalyst stream 176. In some embodiments, separation unit 152 for use herein can include, for example, a cyclone. Although one separation unit 152 is shown in FIGS. 1A and 1B, the number of separation units is merely illustrative and any number can be used in product effluent separation system 148.

Reactor system 100 further includes a compressor 156. Compressor 156 is configured to pressurize clean gas stream 154a to a higher pressure to produce a first pressurized clean gas stream 158a. For example, compressor 156 may be any suitable compressor or rotary pump including an impeller, or alternatively may be any other suitable fluid pump such as a centrifugal pump, a positive displacement pump, etc. Although one compressor 156 is shown in FIGS. 1A and 1B, the number of compressors is merely illustrative and any number can be used in product effluent separation system 148.

In some embodiments, as illustrated in FIG. 1B, separation unit 152 and compressor 156 can be switched such that cooled product effluent 146 is first sent to compressor 156 for compressing cooled product effluent 146 and generating a pressurized cooled product effluent 158b. Pressurized cooled product effluent 158b is then sent to separation unit 152 to separate the spent carbon supported metal catalyst present in pressurized cooled product effluent 158b to generate a first pressurized clean gas stream 154b.

In some embodiments, reactor system 100 may further includes a filtration unit 160 for removing any residue fine particulates such as residue fine solid carbon particulates from the spent carbon supported metal catalyst, if present, in first pressurized clean gas stream 158a (FIG. 1A) or first pressurized clean gas stream 154b (FIG. 1B) and generate a filtered clean gas stream 162 and a solid particulate stream 178. In some embodiments, filtration unit 160 can be a solid-gas separation unit that carries out a solid-gas separation process such as, for example, using a mesh, screen, membrane filtration (e.g., microfiltration processes, using membranes having an average pore size of less than about 10 microns, more particularly, an average pore size of less than about 5 microns, or an average pore size of less than about 2 microns or an average pore size of less than about 1 micron). Although one filtration unit 160 is shown in FIGS. 1A and 1B, the number of filtration units is merely illustrative and any number can be used in product effluent separation system 148.

In some embodiments, filtered clean gas stream 162 is sent to an acid gas scrubber 164 to remove, for example, acid gases such as carbon monoxide, carbon dioxide and water to provide a second pressurized clean gas stream 166 depleted of acid gases.

In some embodiments, acid gas scrubber 164 can receive one of first pressurized clean gas stream 158a (FIG. 1A) or first pressurized clean gas stream 154b (FIG. 1B) or filtered clean gas stream 162, when present.

In some embodiments, acid gas scrubber 164 further receives a solvent or a solvent solution (e.g., an alkaline solution, an amine, cold methanol or other) to absorb the acid gases by means of a reversible chemical absorption process. In some embodiments, a temperature in acid gas scrubber 164 can be from ambient to about 65° C. In some embodiments, a pressure in acid gas scrubber 164 can vary widely. For example, in some embodiments, a pressure in acid gas scrubber 164 can range up to about 5000 psig, e.g., from about 100 psig to about 5000 psig, or from about 3000 psig to about 5000 psig. In some embodiments, a pressure in acid gas scrubber 164 can range from about 500 psig to about 1200 psig. In some embodiments, a pressure in acid gas scrubber 164 can range from about 7 atm to about 300 atm, or from about 7 atm to about 80 atm.

The loaded solvent can then be regenerated in a stripping unit (not shown) where the acid gases such as carbon dioxide get released and the lean solvent is recovered and circulated in closed circuit to the absorber. Although one acid gas scrubber 164 is shown in FIGS. 1A and 1B, the number of acid gas scrubbers is merely illustrative and any number can be used in product effluent separation system 148.

In some embodiments, a gas dehydration facility can be employed to remove moisture from the reactor system's outlet stream (not shown). In general, a gas dehydration process involves extracting water from a gas derived from light hydrocarbons such as natural gas. In some embodiments, second pressurized clean gas stream 166 can be sent to a dryer 168 to remove residual moisture and provide a dried cleaned gas stream 170. For example, dryer 168 can be a dehydrating unit using, for example, a glycol. A suitable dryer includes, for example, a liquid absorption system using glycols or a solid desiccant adsorption system. Suitable liquid desiccants include, for example, tri-ethylene glycol (TEG), di-ethylene glycol (DEG), ethylene glycol (MEG), and tetra-ethylene glycol (TREG). Suitable solid desiccants include, for example, regenerable solid desiccants such as silica gel, alumina, and molecular sieves, or non-regenerable solid desiccants such as CaCl1, can also be used. Although one dryer 168 is shown in FIGS. 1A and 1B, the number of dryers is merely illustrative and any number can be used in product effluent separation system 148.

Reactor system 100 further includes sending dried cleaned gas stream 170 to hydrogen purification unit 172 to separate the hydrogen fraction from the unreacted light hydrocarbons such as methane and other gas species to produce a high purity hydrogen product 174 and recycled light hydrocarbon stream 114. In some embodiments, hydrogen purification unit 172 uses an adsorption process, such as a pressure swing adsorption (PSA) process, a cryogenic process or an absorption process, to separate hydrogen from the unreacted light hydrocarbons. In some embodiments, hydrogen purification unit 172 is a pressure swing adsorption (PSA) unit comprising one or more adsorption beds for separating hydrogen and/or a membrane unit such as a hydrogen membrane separation unit. In some embodiments, the PSA includes an adsorbent material comprising carbon, silica, zeolites, metal organic frameworks, or combinations thereof. The working principle of a PSA unit may be understood as follows: PSA comprises a physical separation process that allows small molecules, e.g., hydrogen, to pass through while trapping larger molecules (the adsorbate), e.g., the unreacted light hydrocarbons.

The membrane unit is hydrogen selective, in that it selectively permeates hydrogen. Various hydrogen membrane separation membranes are known in the art. In some embodiments, a hydrogen separation membrane can be configured from an inorganic material, a metallic material, an organic material, or a composite material of those materials. In some embodiments, a hydrogen separation membrane can be an inorganic membrane including, for example, a zeolite membrane, a silica membrane, an alumina membrane, and composite membranes thereof. In some embodiments, a hydrogen separation membrane can be an organic membrane including, for example, a polysulfone membrane, a polyimide membrane, a polyamide membrane, a cellulose acetate membrane and composite membranes thereof. In some embodiments, a hydrogen separation membrane can be a metallic membrane including, for example, a palladium membrane. In some embodiments, a hydrogen separation membrane is a polyimide-based membrane. In some embodiments, a hydrogen separation membrane is a polyamide-based membrane.

The hydrogen separation membrane may have many different shapes and sizes, such as, for example, in the form of a spiral wound membrane, a hollow fiber membrane, a tube membrane or a plate membrane. The actual selectivity for hydrogen can depend on the material that the hydrogen separation membrane is made out of, as well as the process conditions, including the temperature and the pressure on the feed side and the permeate side, respectively.

Although one hydrogen purification unit 172 is shown in FIGS. 1A and 1B, the number of hydrogen purification units is merely illustrative and any number can be used in product effluent separation system 148.

In some embodiments, high purity hydrogen product 174 can have a purity of greater than or equal to about 90%, or greater than or equal to about 95%, or greater than or equal to about 99.9%.

In one embodiment, recycled light hydrocarbon stream 114 is rejected tail gas containing unreacted methane.

### Acid Leaching System and Fresh Catalyst Synthesis System

Reactor system 100 further includes an acid leaching system 182 and a fresh catalyst synthesis system 184. In some embodiments, a first portion of cooled spent carbon supported metal catalyst 150 is combined with a portion of spent carbon supported metal catalyst stream 176 and sent to acid leaching system 182 as a spent carbon supported metal catalyst stream 186. In some embodiments, a portion of spent carbon supported metal catalyst stream 176 and solid particulate stream 178 exit reactor system 100 as a low purity solid carbon product 180. In some embodiments, low purity solid carbon product 180 can have a purity of less than 95% or from about 80% to less than 95%.

Acid leaching system 182 further receives a leaching solution stream 188 for contacting spent carbon supported metal catalyst stream 186. In some embodiments, leaching solution stream 188 is an aqueous acid solution. In some embodiments, leaching solution stream 188 is an acidic leaching solution, such as an aqueous nitric acid solution, containing an acid at a respective concentration in the range of about 0.1 M to about 15 M, or from about 0.5 M to about 10 M, or from about 3 M to about 10 M, with a pH of less than 3. Suitable acids include, for example, hydrochloric acid, sulfuric acid, nitric acid, phosphoric acid, or a mixture thereof.

Leaching solution stream 188 enters acid leaching system 182 for contacting spent carbon supported metal catalyst stream 186 to extract one or more active metal compounds in spent carbon supported metal catalyst stream 186. For example, as discussed above, the spent carbon supported metal catalyst can contain one or more active metal compounds such as Ni, Fe, Cu, Tb, Zn, Co, Pd, Sn, etc. Thus, in some embodiments, the aqueous acid solution allows the one or more active metal compounds to be converted to their corresponding salt and thus dissolved (i.e., solubilized) in leaching solution stream 188. In some embodiments, the leaching process may be conducted at a temperature in the range of from about 25° C. to about 200° C., or from about 50° C. to about 150° C., or from about 80° C. to about 120° C., and a pressure in the range of from about 1 atm to about 5 atm, or from 1.2 atm to about 2.5 atm. Determination of the optimum operating conditions are within the skill of the art and will vary with the one or more active metal compounds to be solubilized and the composition of solid carbon stream 190.

In some embodiments, acid leaching system 182 can further include one or more separation units (not shown) to separate the solid carbon deposits of the spent carbon supported metal catalyst from leaching solution stream 188 with the one or more active metal compounds to produce a solid carbon stream 190 containing a high purity solid carbon product and an extract stream 192 of leaching solution stream 188 with dissolved one or more active metal compounds. In some embodiments, one or more steps of acid leaching may be further applied to solid carbon stream 190 to further reduce the metal concentration and to further purify the solid carbon product and produce a high purity solid carbon product for high added values.

In some embodiments, solid carbon stream 190 contains the high purity solid carbon product having a purity of greater than or equal to 95% or greater than or equal to at least about 99.9%.

Extract stream 192 containing the one or more active metal compounds and any remaining solid carbon deposits are discharged from acid leaching system 182 and sent to fresh catalyst synthesis system 184. In some embodiments, fresh catalyst synthesis system 184 receives another portion of cooled spent carbon supported metal catalyst 194 with solid carbon deposit, extract stream 192 and an active metal stream 196. Suitable active metals for active metal stream 196 include, for example, the desired metal compounds discussed above such as Ni/Fe to impregnate onto the solid carbon in the spent catalyst to provide fresh carbon supported metal catalyst stream 134. Thus, the desired metals will be selected depending on, for example, the particular light hydrocarbon feed stream, the reactor, the operating conditions, etc. In some embodiments, the active metal stream 196 can be an aqueous solution containing the active metal compound(s) at a respective concentration in the range of from about 1 wt. % to about 40 wt. %, or from about 5 wt. % to about 20 wt. %.

In some embodiments, fresh catalyst synthesis system 184 can further contain one or more separators, dryers and furnaces (not shown) to separate any solids from the aqueous solution and calcine the solids to further produce fresh carbon supported metal catalyst stream 134. In a further embodiment, the resulting aqueous solution can be recycled or reused for catalyst synthesis with the active metal compounds being added.

The non-limiting illustrative embodiment of FIG. 2 will now be described in more detail.

### Sprouted Bed Reactor

Referring now to the drawings in more detail, FIG. 2 illustrates a reactor system 200 utilizing a sprouted bed reactor 202 and a catalyst regeneration unit and riser 204 (hereinafter riser 204) for producing a product effluent comprising a gas stream comprising hydrogen and unreacted light hydrocarbons, solid carbon and a spent carbon supported metal catalyst. In some embodiments, the product effluent further includes acid gases such as carbon monoxide, carbon dioxide and water. It is to be understood that reactor system 200 including at least sprouted bed reactor 202 and riser 204 is not limited to the configuration of the embodiments shown in FIG. 2, and other configurations are contemplated herein. In some embodiments, each of sprouted bed reactor 202 and catalyst regeneration unit and riser 204 can have an interior wall formed from a reactor lining having one or more layers of a refractory material to reduce heat loss and sustain the high temperatures in reactor system 200.

Sprouted bed reactor 202 has a reactor wall that defines a reaction zone 206. In a non-limiting illustrative embodiment, sprouted bed reactor 202 may have a cylindrical configuration with a varying diameter along portions of its length of reactor wall. In another non-limiting illustrative embodiment, sprouted bed reactor 202 may have a cylindrical configuration with a top portion having a first diameter D1 along its length of reactor wall, a bottom portion having a second diameter D2 along its length of reactor wall and a middle portion having a tapered configuration along its length of reactor wall (i.e., transitioning diameter from D1 to D2). In some embodiments, the first diameter D1 is greater than the diameter of second diameter D2. However, as one skilled in the art will appreciate, the cylindrical configuration is merely illustrative and any other suitable shape of the same or varying diameters are contemplated herein.

Sprouted bed reactor 202 further includes a first separator 207a such as a cyclone located at a top of top portion of sprouted bed reactor 202. First separator 207a receives a reaction stream comprising a gas stream comprising hydrogen and unreacted light hydrocarbons, and a spent carbon supported metal catalyst comprising one or more active metal compounds and solid carbon deposits produced from cracking the light hydrocarbon feed stream in the presence of the regenerated carbon supported metal catalyst and a fresh carbon supported metal catalyst stream 234 as discussed below. In some embodiments, the reaction stream further includes acid gases such as carbon monoxide, carbon dioxide and water. First separator 207a then separates a first portion of the spent carbon supported metal catalyst from the reaction stream to generate a product effluent 208 comprising a gas stream comprising hydrogen and unreacted light hydrocarbons including a second portion of the spent carbon supported metal catalyst comprising the one or more active metal compounds and the solid carbon deposits which then exits sprouted bed reactor 202 as discussed above for product effluent 108. The first portion of the spent carbon supported metal catalyst then flows downward from first separator 207a to the bottom portion of sprouted bed reactor 202. Although one separator is shown for first separator 207a, the number of separators is merely illustrative and any number can be used in sprouted bed reactor 202 based on such factors as, for example, reactor design, etc.

The first portion of spent carbon supported metal catalyst then flows downward from first separator 207a to the bottom portion of sprouted bed reactor 202. In some embodiments, the first portion of spent carbon supported metal catalyst flows downward by, for example, gravity forces. Spent carbon supported metal catalyst is then split into two streams, namely, a spent carbon supported metal catalyst 205-1 and a spent carbon supported metal catalyst 205-2.

Sprouted bed reactor 202 further includes riser 204 for receiving spent carbon supported metal catalyst 205-2 from first separator 207a via a catalyst transfer line in fluid communication with sprouted bed reactor 202 and riser 204. In one embodiment, loop seals are present in the catalyst transfer line to separate any highly flammable hydrocarbon gases present in sprouted bed reactor 202 from any oxidizing gas present in riser 204. In some embodiments, steam can also be injected in the catalyst transfer line to keep the transfer line fluidized. The steam pressure is sufficient to act as a gas barrier between sprouted bed reactor 202 and riser 204 to prevent or inhibit any mixing of the oxidizing gas and hydrocarbon gases.

In an illustrative embodiment, riser 204 includes a gas inlet adapted to receive an oxidizing gas stream 201 into riser 204. The gas inlet may be disposed at the bottom of riser 204. However, this is merely illustrative and other locations for the gas inlet are contemplated herein. As discussed below, solid carbon is formed on the surface of spent carbon supported metal catalyst 205-2. In some embodiments, a portion of the solid carbon can be burned from spent carbon supported metal catalyst 205-2 by exposing spent carbon supported metal catalyst 205-2 to oxidizing gas stream 201, e.g., an inert gas/air such as air, oxygen, nitrogen, methane, or combinations thereof or a steam/air mixture, at appropriate high temperature and time duration conditions to burn off a portion of the solid carbon deposits from the catalyst particles. A regenerated carbon supported metal catalyst is thereby produced including heated catalyst particles. In some embodiments, the regenerated carbon supported metal catalyst will be heated to a desired temperature to carry thermal energy necessary for the endothermic reactions of a third heated light hydrocarbon feed stream 230 that take place inside reaction zone 206 in sprouted bed reactor 202. In an illustrative embodiment, a temperature can range from about 450° C. to about 1400° C., and a time period can range from about 10 seconds to about 60 minutes.

In some embodiments, oxidizing gas stream 201 combusts with spent carbon supported metal catalyst 205-2 where a portion of the sold carbon is burnt from spent carbon supported metal catalyst 205-2 while producing the regenerated carbon supported metal catalyst. Accordingly, regenerating the spent catalyst generally comprises combustion of spent carbon supported metal catalyst 205-2 in an oxidizing atmosphere to burn a portion of the solid carbon and redisperse active metal on the catalyst particles. Burning the solid carbon is an exothermic process that can supply the heat needed for the reaction process. In a heat balanced operation, the quantity of solid carbon formed on the catalyst is significant enough that no external heat source or fuel is needed to supplement the heat from combustion.

The solid carbon burn causes spent carbon supported metal catalyst 205-2 to be heated to an elevated temperature, e.g., a temperature of from about 450° C. to about 1400° C. or from about 600° C. to about 1400° C. or from about 450° C. to about 1200° C., to provide a mixture of the regenerated carbon supported metal catalyst wherein the catalyst particles are heated, and a heated gas effluent, i.e., stream 203. In some embodiments, the heated gas effluent is regenerator flue gas composed of, for example, carbon dioxide and nitrogen.

The heat generated by the solid carbon burn in riser 204 is also continuously transferred with stream 203 composed of the mixture of the regenerated carbon supported metal catalyst and the heated gas effluent which flows upwards and is continuously passed out of riser 204 into a second separator 207b such as a cyclone.

In an illustrative embodiment, a top portion of riser 204 is operatively connected to a top portion of second separator 207b and a bottom portion of riser 204 is operatively connected to sprouted bed reactor 202 via the catalyst transfer line. In some embodiments, riser 204 is essentially a pipe with a suitable diameter to allow both gas and solids to flow upwardly in a pneumatic transferring regime, i.e., the spent carbon supported metal catalyst comprising active metal compound and solid carbon deposits can be introduced to riser 204 in the presence of oxidizing gas stream 201 at the bottom of riser 204 in which the gas flow is sufficiently high to pneumatically transport stream 203 composed of the mixture of the heated regenerated carbon supported metal catalyst and the heated gas effluent into second separator 207b. In some embodiments, riser 204 is a vessel with top and bottom sections of different diameters.

Second separator 207b is located in aa top portion of sprouted bed reactor 202. In some embodiments, second separator 207b extends beyond a top surface of the top portion of sprouted bed reactor 202 and is external to sprouted bed reactor 202. In some embodiments, second separator 207b includes a first portion located internally in sprouted bed reactor 202 and a second portion located externally from sprouted bed reactor 202 and extending above a top surface of the top portion of sprouted bed reactor 202 operatively connected to the top portion of riser 204. Second separator 207b receives stream 203 from riser 204 and then separates the heated gas effluent from the regenerated carbon supported metal catalyst to generate a product gas effluent which exits second separator 207b for further product processing (not shown). Although one separator is shown for second separator 207b, the number of separators is merely illustrative and any number can be used in sprouted bed reactor 202 based on such factors as, for example, reactor design, etc.

The regenerated carbon supported metal catalyst then flows downward from second separator 207b into the top portion of sprouted bed reactor 202 and to reaction zone 206. In operation, third heated light hydrocarbon feed stream 230 is introduced into sprouted bed reactor 202 and flows upward utilizing a gas sparger or a flow distributor to reaction zone 206 for cracking with the regenerated carbon supported metal catalyst. In some embodiment, fresh carbon supported metal catalyst stream 234 is introduced to assist with the cracking of third heated light hydrocarbon feed stream 230.

In illustrative embodiments, the reaction conditions include, for example, a temperature of from about 500° C. to about 1200° C., and for a residence time of third heated light hydrocarbon feed stream 230 in sprouted bed reactor 202 of from about 0.05 seconds to about 100 seconds, or from about 0.1 seconds to about 2 seconds.

Product effluent 208 comprising (i) a gas stream comprising hydrogen and unreacted light hydrocarbons and (ii) the spent carbon supported metal catalyst comprising the one or more active metal compounds and the solid carbon deposits exits sprouted bed reactor 202 at a temperature ranging from about 500° C. to about 1200° C. and enters a heat exchanger 220 to transfer heat to a light hydrocarbon feed stream 216. Light hydrocarbon feed stream 216 includes an incoming light hydrocarbon feed stream 212 and a recycled light hydrocarbon feed stream 214 from a hydrogen purification unit 272 as discussed below.

Heat exchanger 220 receives product effluent 208 as a heat transfer medium to generate a first heated light hydrocarbon feed stream 222 for sending to a heat exchanger 224, and a cooled product effluent 246 for sending to a product effluent separation system 248. In other words, product effluent 208 delivers the heat in heat exchanger 220 to light hydrocarbon feed stream 216 and generates first heated light hydrocarbon feed stream 222 having a temperature of from about 100° C. to about 600° C., and product effluent 208 is likewise cooled against light hydrocarbon feed stream 216 in heat exchanger 220 to generate cooled product effluent 246 having a temperature of from about 20° C. to about 300° C. In some embodiments, heat exchanger 220 may be a shell-and-tube, plate-fin, microchannel, spiral wound, or any other suitable heat exchanger.

Spent carbon supported metal catalyst 205-1 exits sprouted bed reactor 202 at a temperature ranging from about 500° C. to about 1200° C. and enters heat exchanger 224 to transfer heat to first heated light hydrocarbon feed stream 222. In other words, spent carbon supported metal catalyst 205-1 delivers the heat in heat exchanger 224 to first heated light hydrocarbon feed stream 222 and generates a second heated light hydrocarbon feed stream 226 having a temperature of from about 300° C. to about 1000° C., and spent carbon supported metal catalyst 205-1 is likewise cooled against first heated light hydrocarbon feed stream 222 to generate a cooled spent carbon supported metal catalyst 250 having a temperature of from about 100° C. to about 500° C. In some embodiments, heat exchanger 224 may be a shell-and-tube, plate-fin, microchannel, spiral wound, or any other suitable heat exchanger.

In some embodiments, a heat exchanger 228 is utilized to further heat second heated light hydrocarbon feed stream 226, if necessary, to generate a third heated light hydrocarbon feed stream 230 for sending to sprouted bed reactor 202 as discussed above. In some embodiments, heat exchanger 228 may be a shell-and-tube, plate-fin, microchannel, spiral wound, or any other suitable heat exchanger.

### Product Effluent Separation System

Reactor system 200 further includes product effluent separation system 248 for processing cooled product effluent 246 to produce a high purity hydrogen product 274. Product effluent separation system 248 includes a separation unit 252 for receiving cooled product effluent 246 comprising (i) a gas stream comprising hydrogen and unreacted light hydrocarbons and (ii) the spent carbon supported metal catalyst comprising the one or more active metal compounds and the solid carbon deposits. Separation unit 252 separates the spent carbon supported metal catalyst present in cooled product effluent 246 to generate a clean gas stream 254 comprising hydrogen and unreacted light hydrocarbons, and a spent carbon supported metal catalyst stream 276. In some embodiments, separation unit 252 for use herein can include, for example, a cyclone. Although one separation unit 252 is shown, the number of separation units is merely illustrative and any number can be used in product effluent separation system 248.

Reactor system 200 further includes a compressor 256. Compressor 256 is configured to pressurize clean gas stream 254 to a higher pressure to produce a first pressurized clean gas stream 258. For example, compressor 256 may be any suitable compressor or rotary pump including an impeller, or alternatively may be any other suitable fluid pump such as a centrifugal pump, a positive displacement pump, etc. Although one compressor 256 is shown, the number of compressors is merely illustrative and any number can be used in product effluent separation system 248. In some embodiments, separation unit 252 and compressor 256 can be switched as discussed above with reference to FIGS. 1A and 1B.

In some embodiments, reactor system 200 may further includes a filtration unit 260 for removing any residue fine particulates such as residue fine solid carbon particulates, if present, in first pressurized clean gas stream 258 and generate a filtered clean gas stream 262 and a solid particulate stream 278. In some embodiments, filtration unit 260 can be a solid-gas separation as discussed above for filtration unit 160. Although one filtration unit 260 is shown, the number of filtration units is merely illustrative and any number can be used in product effluent separation system 248.

In some embodiments, filtered clean gas stream 262 is sent to an acid gas scrubber 264 to remove, for example, acid gases such as carbon monoxide, carbon dioxide and water to provide a second pressurized clean gas stream 266 depleted of acid gases. In some embodiments, acid gas scrubber 264 can receive one of first pressurized clean gas stream 258 or filtered clean gas stream 262, when present, and a solvent or a solution (e.g., an alkaline solution, an amine, cold methanol or other) to absorb the acid gases by means of a reversible chemical absorption process. In some embodiments, a temperature in acid gas scrubber 264 can be from ambient to about 65° C. In some embodiments, a pressure in acid gas scrubber 264 can vary widely. For example, in some embodiments, a pressure in acid gas scrubber 264 can range up to about 5000 psig, e.g., from about 100 psig to about 5000 psig, or from about 3000 psig to about 5000 psig. In some embodiments, a pressure in acid gas scrubber 264 can range from about 500 psig to about 1200 psig. In some embodiments, a pressure in acid gas scrubber 264 can range from about 7 atm to about 300 atm, or from about 7 atm to about 80 atm.

The loaded solvent can then be regenerated in a stripping unit (not shown) where the acid gases such as carbon dioxide get released and the lean solvent recovered and circulated in closed circuit to the absorber. Although one acid gas scrubber 264 is shown, the number of acid gas scrubbers is merely illustrative and any number can be used in product effluent separation system 248.

In some embodiments, a gas dehydration facility can be employed to remove moisture from the reactor system's outlet stream (not shown). In general, a gas dehydration process involves extracting water from a gas derived from light hydrocarbons such as natural gas. In some embodiments, second pressurized clean gas stream 266 can be sent to a dryer 268 to remove residual moisture and provide a dried cleaned gas stream 270 as discussed above for dryer 168. For example, dryer 268 can be a dehydrating unit using, for example, a glycol. Although one dryer 268 is shown, the number of dryers is merely illustrative and any number can be used in product effluent separation system 248.

Reactor system 200 further includes sending dried cleaned gas stream 270 to hydrogen purification unit 272 to separate the hydrogen fraction from the unreacted light hydrocarbons such as methane and other gas species to produce a high purity hydrogen 274 and recycled light hydrocarbon feed stream 214. In some embodiments, hydrogen purification unit 272 can be a similar unit as discussed above for hydrogen purification unit 172. Although one hydrogen purification unit 272 is shown, the number of hydrogen purification units is merely illustrative and any number can be used in product effluent separation system 248.

In some embodiments, high purity hydrogen product 274 can have a purity of greater than or equal to about 90%, or greater than or equal to about 95%, or greater than or equal to about 99.9%.

In one embodiment, recycled light hydrocarbon feed stream 214 is rejected tail gas containing unreacted methane.

### Acid Leaching System and Fresh Catalyst Synthesis System

Reactor system 200 further includes an acid leaching system 282 and a fresh catalyst synthesis system 284. In some embodiments, a first portion of cooled spent carbon supported metal catalyst 250 is combined with a portion of spent carbon supported metal catalyst stream 276 and sent to acid leaching system 282 as a spent carbon supported metal catalyst stream 286. In some embodiments, a portion of spent carbon supported metal catalyst stream 276 and solid particulate stream 278 exit reactor system 200 as a low purity solid carbon product 280. In some embodiments, low purity solid carbon product 280 can have a purity of less than 95% or from about 80% to less than 95%.

Acid leaching system 282 further receives a leaching solution stream 288 for contacting spent carbon supported metal catalyst stream 286. In some embodiments, leaching solution stream 288 is an aqueous acid solution as described above for acid leaching system 282. Leaching solution stream 288 enters acid leaching system 282 for contacting spent carbon supported metal catalyst stream 286 to extract active metal compounds in spent carbon supported metal catalyst stream 286. For example, the aqueous acid solution allows the active metal compounds to be converted to their corresponding salt and thus dissolved in the aqueous acid solution. In some embodiments, the leaching process may be conducted at a temperature in the range of from about 25° C. to about 200° C., or from about 50° C. to about 150° C., or from about 80° C. to about 120° C., and a pressure in the range of from about 1 atm to about 5 atm, or from 1.2 atm to about 2.5 atm. Determination of the optimum operating conditions are within the skill of the art and will vary with the active metal compounds to be solubilized and the composition of solid carbon stream 290.

In some embodiments, acid leaching system 282 can further include one or more separation units (not shown) to separate the solid carbon deposits of the spent carbon supported metal catalyst from leaching solution stream 288 with the active metal compounds to produce a solid carbon stream 290 containing a high purity solid carbon product and an extract stream 292 of the leaching solution stream with dissolved metal compounds. In some embodiments, one or more steps of acid leaching may be further applied to solid carbon stream 290 to further reduce the metal concentration and to further purify the solid carbon product and produce a high purity solid carbon product for high added values.

In some embodiments, solid carbon stream 290 contains the high purity solid carbon product having a purity of greater than or equal to 95% or greater than or equal to about 99.9%.

Extract stream 292 containing the active metal compounds and any remaining solids are discharged from acid leaching system 282 and sent to fresh catalyst synthesis system 284. In some embodiments, fresh catalyst synthesis system 284 receives another portion of cooled spent carbon supported metal catalyst 294 with solid carbon deposit, extract stream 292 and an active metal stream 296. Suitable active metals for active metal stream 296 include, for example, the desired metal compounds discussed above such as Ni/Fe to impregnate onto the solid carbon in the spent catalyst to provide fresh carbon supported metal catalyst stream 234. Thus, the desired metals will be selected depending on, for example, the particular light hydrocarbon feed stream, the reactor, the operating conditions, etc. In some embodiments, active metal stream 296 can be an aqueous solution containing the active metal compound(s) at a respective concentration in the range of from about 1 wt. % to about 40 wt. %, or from about 5 wt. % to about 20 wt. %.

In some embodiments, fresh catalyst synthesis system 284 can further contain one or more separators, dryers and furnaces (not shown) to separate any solids from the aqueous solution and calcine the solids to further produce fresh carbon supported metal catalyst stream 234. In a further embodiment, the resulting aqueous solution can be recycled or reused for catalyst synthesis with the active metal compounds being added.

According to an aspect of the present disclosure, a process for producing high purity hydrogen comprises:
separating a gas stream comprising hydrogen and unreacted light hydrocarbons from a product effluent comprising the gas stream comprising the hydrogen and the unreacted light hydrocarbons, and a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor,
separating the hydrogen and the unreacted light hydrocarbons from the gas stream comprising the hydrogen and the unreacted light hydrocarbons, and
withdrawing high purity hydrogen.

In one or more additional illustrative embodiments, as may be combined with the preceding paragraphs, the process comprises, prior to separating the gas stream comprising the hydrogen and the unreacted light hydrocarbons from the product effluent comprising the gas stream comprising the hydrogen and the unreacted light hydrocarbons, and the spent carbon supported metal catalyst comprising the one or more active metal compounds and the solid carbon deposits, compressing the product effluent comprising (i) the gas stream comprising the hydrogen and the unreacted light hydrocarbons and (ii) the spent carbon supported metal catalyst comprising the one or more active metal compounds and the solid carbon deposits.

In one or more additional illustrative embodiments, as may be combined with the preceding paragraphs, the process comprises, prior to separating the hydrogen and the unreacted light hydrocarbons, compressing the gas stream comprising the hydrogen and the unreacted light hydrocarbons.

In one or more additional illustrative embodiments, as may be combined with the preceding paragraphs, the gas stream further comprises one or more acid gases, and the process further comprises, prior to separating the hydrogen and the unreacted light hydrocarbons from the gas stream, separating the acid gases from the gas stream using one or more acid gas scrubbers.

In one or more additional illustrative embodiments, as may be combined with the preceding paragraphs, separating the hydrogen and the unreacted light hydrocarbons from the gas stream comprises passing the gas stream to a hydrogen separation membrane, a pressure swing adsorption system, or both.

In one or more additional illustrative embodiments, as may be combined with the preceding paragraphs, separating the hydrogen and the unreacted light hydrocarbons from the gas stream comprises passing the gas stream to a hydrogen separation membrane, a pressure swing adsorption system, or both.

In one or more additional illustrative embodiments, as may be combined with the preceding paragraphs, the high purity hydrogen has a purity greater than or equal to 95%.

In one or more additional illustrative embodiments, as may be combined with the preceding paragraphs, the high purity hydrogen has a purity greater than or equal to 99.9%.

In one or more additional illustrative embodiments, as may be combined with the preceding paragraphs, the process further comprises receiving a first portion of another spent carbon supported metal catalyst comprising one or more active metal compounds and solid carbon deposits received from the reactor, and the process further comprises:
contacting one or more of the first portion of the other spent carbon supported metal catalyst comprising the one or more active metal compounds and the solid carbon deposits received from the reactor and the spent carbon supported metal catalyst comprising the one or more active metal compounds and the solid carbon deposits separated from the gas stream of the product effluent with a leaching solution to solubilize the one or more active metal compounds from the one or more of the first portion of the other spent carbon supported metal catalyst comprising the one or more active metal compounds and the solid carbon deposits received from the reactor and the spent carbon supported metal catalyst comprising the one or more active metal compounds and the solid carbon deposits separated from the gas stream of the product effluent to generate a solubilized leaching solution comprising solubilized metal and a solid carbon product, and
separating the solid carbon product from the solubilized leaching solution, wherein the solid carbon product is a high purity solid carbon product.

In one or more additional illustrative embodiments, as may be combined with the preceding paragraphs, the high purity solid carbon product has a purity greater than or equal to 95%.

In one or more additional illustrative embodiments, as may be combined with the preceding paragraphs, the one or more active metal compounds are selected from the group consisting of Ni, Fe, Cu, Tb, Zn, Co, Pd and Sn.

In one or more additional illustrative embodiments, as may be combined with the preceding paragraphs, the leaching solution is an acid leaching solution comprising an acid selected from the group consisting of hydrochloric acid, sulfuric acid, nitric acid, phosphoric acid and combinations thereof.

In one or more additional illustrative embodiments, as may be combined with the preceding paragraphs, the process further comprises contacting the solubilized leaching solution with a second portion of the other spent carbon supported metal catalyst comprising the one or more active metal compounds and the solid carbon deposits and an aqueous solution stream comprising one or more other active metal compounds to generate a fresh carbon supported metal catalyst.

In one or more additional illustrative embodiments, as may be combined with the preceding paragraphs, the process further comprises combining the unreacted light hydrocarbons separated from the gas stream with a light hydrocarbon feed stream to form an incoming light hydrocarbon feed stream,
heating the incoming light hydrocarbon feed stream in a first heat exchanger using another product effluent comprising (i) a gas stream comprising hydrogen and unreacted light hydrocarbons and (ii) a spent carbon supported metal catalyst comprising one or more active metal compounds and solid carbon deposits derived from catalytically cracking another light hydrocarbon feedstock in the reactor to generate a first heated incoming light hydrocarbon feed stream,
heating the first heated incoming light hydrocarbon feed stream in a second heat exchanger using another spent carbon supported metal catalyst comprising one or more active metal compounds and solid carbon deposits received from the reactor to generate a second heated incoming light hydrocarbon feed stream, and
passing the second heated incoming light hydrocarbon feed stream to the reactor.

In one or more additional illustrative embodiments, as may be combined with the preceding paragraphs, the light hydrocarbon feedstock comprises natural gas.

According to another aspect of the present disclosure, a reactor system comprises:
a reactor configured to catalytically crack a light hydrocarbon feed stream in the presence of a carbon supported metal catalyst comprising one or more active metal compounds to generate a product effluent comprising (i) a gas stream comprising hydrogen and unreacted light hydrocarbons and (ii) a spent carbon supported metal catalyst comprising one or more active metal compounds and solid carbon deposits,
a first separation unit configured to separate the gas stream comprising the hydrogen and the unreacted light hydrocarbons from the product effluent, and
a second separation unit configured to separate the hydrogen and the unreacted light hydrocarbons from the gas stream to generate high purity hydrogen and a recycle stream comprising the unreacted light hydrocarbons.

In one or more additional illustrative embodiments, as may be combined with the preceding paragraphs, the reactor system further comprises:
a compressor unit configured to compress one of the product effluent comprising (i) the gas stream comprising the hydrogen and the unreacted light hydrocarbons and (ii) the spent carbon supported metal catalyst comprising the one or more active metal compounds and the solid carbon deposits or the gas stream comprising the hydrogen and the unreacted light hydrocarbons received from the first separation unit.

In one or more additional illustrative embodiments, as may be combined with the preceding paragraphs, the gas stream further comprises one or more acid gases, and the reactor system further comprises one or more acid gas scrubbers configured to separate the acid gases from the gas stream received from the first separation unit.

In one or more additional illustrative embodiments, as may be combined with the preceding paragraphs, the reactor system further comprises:
an acid leaching unit configured to solubilize one or more active metal compounds from (i) a first portion of another spent carbon supported metal catalyst comprising one or more active metal compounds and solid carbon deposits received from the reactor and (ii) the spent carbon supported metal catalyst comprising the one or more active metal compounds and the solid carbon deposits received from the first separation unit with a leaching solution to generate a solubilized leaching solution comprising solubilized metal and a solid carbon product, wherein the solid carbon product is a high purity solid carbon product.

In one or more additional illustrative embodiments, as may be combined with the preceding paragraphs, the high purity solid carbon product has a purity greater than or equal to 95%.

In one or more additional illustrative embodiments, as may be combined with the preceding paragraphs, the one or more active metal compounds are selected from the group consisting of Ni, Fe, Cu, Tb, Zn, Co, Pd and Sn.

In one or more additional illustrative embodiments, as may be combined with the preceding paragraphs, the reactor system further comprises
a fresh catalyst synthesis unit configured to contact the solubilized leaching solution with a second portion of the other spent carbon supported metal catalyst comprising the one or more active metal compounds and the solid carbon deposits and an aqueous solution stream comprising one or more other active metal compounds to generate a fresh carbon supported metal catalyst.

In one or more additional illustrative embodiments, as may be combined with the preceding paragraphs, the reactor system further comprises:
a first heat exchanger configured to heat the recycle stream comprising the unreacted light hydrocarbons and a light hydrocarbon feed stream using the product effluent comprising (i) the gas stream comprising the hydrogen and the unreacted light hydrocarbons and (ii) the spent carbon supported metal catalyst comprising the one or more active metal compounds and the solid carbon deposits to generate a first heated light hydrocarbon feed stream, and
a second heat exchanger configured to heat the first heated light hydrocarbon feed stream using another spent carbon supported metal catalyst comprising one or more active metal compounds and solid carbon deposits received from the reactor to generate a second heated combined light hydrocarbon feed stream.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for producing high purity hydrogen, comprising:
separating a gas stream comprising hydrogen and unreacted light hydrocarbons from a product effluent comprising the gas stream comprising the hydrogen and the unreacted light hydrocarbons, and a spent carbon supported metal catalyst comprising one or more active metal compounds and solid carbon deposits derived from catalytically cracking a light hydrocarbon feedstock in the presence of a carbon supported metal catalyst comprising one or more active metal compounds in a reactor;
separating the hydrogen and the unreacted light hydrocarbons from the gas stream comprising the hydrogen and the unreacted light hydrocarbons; and
withdrawing high purity hydrogen.

2. The process according to claim 1, comprising, prior to separating the gas stream comprising the hydrogen and the unreacted light hydrocarbons from the product effluent comprising the gas stream comprising the hydrogen and the unreacted light hydrocarbons, and the spent carbon supported metal catalyst comprising the one or more active metal compounds and the solid carbon deposits, compressing the product effluent comprising (i) the gas stream comprising the hydrogen and the unreacted light hydrocarbons and (ii) the spent carbon supported metal catalyst comprising the one or more active metal compounds and the solid carbon deposits.

3. The process according to claim 1, comprising, prior to separating the hydrogen and the unreacted light hydrocarbons, compressing the gas stream comprising the hydrogen and the unreacted light hydrocarbons.

4. The process according to claim 1, wherein the gas stream further comprises one or more acid gases, and the process further comprises, prior to separating the hydrogen and the unreacted light hydrocarbons from the gas stream, separating the acid gases from the gas stream using one or more acid gas scrubbers.

5. The process according to claim 4, wherein separating the hydrogen and the unreacted light hydrocarbons from the gas stream comprises passing the gas stream to a hydrogen separation membrane, a pressure swing adsorption system, or both.

6. The process according to claim 1, wherein separating the hydrogen and the unreacted light hydrocarbons from the gas stream comprises passing the gas stream to a hydrogen separation membrane, a pressure swing adsorption system, or both.

7. The process according to claim 1, wherein the high purity hydrogen has a purity greater than or equal to 95%.

8. The process according to claim 1, further comprising receiving a first portion of another spent carbon supported metal catalyst comprising one or more active metal compounds and solid carbon deposits received from the reactor, and the process further comprises:
contacting one or more of the first portion of the other spent carbon supported metal catalyst comprising the one or more active metal compounds and the solid carbon deposits received from the reactor and the spent carbon supported metal catalyst comprising the one or more active metal compounds and the solid carbon deposits separated from the gas stream of the product effluent with a leaching solution to solubilize the one or more active metal compounds from the one or more of the first portion of the other spent carbon supported metal catalyst comprising the one or more active metal compounds and the solid carbon deposits received from the reactor and the spent carbon supported metal catalyst comprising the one or more active metal compounds and the solid carbon deposits separated from the gas stream of the product effluent to generate a solubilized leaching solution comprising solubilized metal and a solid carbon product; and
separating the solid carbon product from the solubilized leaching solution, wherein the solid carbon product is a high purity solid carbon product.

9. The process according to claim 8, wherein the high purity solid carbon product has a purity greater than or equal to 95%.

10. The process according to claim 8, wherein the one or more active metal compounds are selected from the group consisting of Ni, Fe, Cu, Tb, Zn, Co, Pd and Sn.

11. The process according to claim 8, wherein the leaching solution is an acid leaching solution comprising an acid selected from the group consisting of hydrochloric acid, sulfuric acid, nitric acid, phosphoric acid and combinations thereof.

12. The process according to claim 8, further comprising contacting the solubilized leaching solution with a second portion of the other spent carbon supported metal catalyst comprising the one or more active metal compounds and the solid carbon deposits and an aqueous solution stream comprising one or more other active metal compounds to generate a fresh carbon supported metal catalyst.

13. The process according to claim 1, further comprising:
combining the unreacted light hydrocarbons separated from the gas stream with a light hydrocarbon feed stream to form an incoming light hydrocarbon feed stream;
heating the incoming light hydrocarbon feed stream in a first heat exchanger using another product effluent comprising (i) a gas stream comprising hydrogen and unreacted light hydrocarbons and (ii) a spent carbon supported metal catalyst comprising one or more active metal compounds and solid carbon deposits derived from catalytically cracking another light hydrocarbon feedstock in the reactor to generate a first heated incoming light hydrocarbon feed stream;
heating the first heated incoming light hydrocarbon feed stream in a second heat exchanger using another spent carbon supported metal catalyst comprising one or more active metal compounds and solid carbon deposits received from the reactor to generate a second heated incoming light hydrocarbon feed stream; and
passing the second heated incoming light hydrocarbon feed stream to the reactor.

14. The process according to claim 1, wherein the light hydrocarbon feedstock comprises natural gas.

15. A reactor system, comprising:
a reactor configured to catalytically crack a light hydrocarbon feed stream in the presence of a carbon supported metal catalyst comprising one or more active metal compounds to generate a product effluent comprising (i) a gas stream comprising hydrogen and unreacted light hydrocarbons and (ii) a spent carbon supported metal catalyst comprising one or more active metal compounds and solid carbon deposits;
a first separation unit configured to separate the gas stream comprising hydrogen from the product effluent comprising (i) the gas stream comprising the hydrogen and the unreacted light hydrocarbons, and (ii) the spent carbon supported metal catalyst comprising the one or more active metal compounds and the solid carbon deposits; and
a second separation unit configured to separate the hydrogen and the unreacted light hydrocarbons from the gas stream to generate high purity hydrogen and a recycle stream comprising the unreacted light hydrocarbons.

16. The reactor system according to claim 15, further comprising:
a compressor unit configured to compress one of the product effluent comprising (i) the gas stream comprising the hydrogen and the unreacted light hydrocarbons and (ii) the spent carbon supported metal catalyst comprising the one or more active metal compounds and the solid carbon deposits or the gas stream comprising the hydrogen and the unreacted light hydrocarbons received from the first separation unit.

17. The reactor system according to claim 15, wherein the gas stream further comprises one or more acid gases, and the reactor system further comprises one or more acid gas scrubbers configured to separate the acid gases from the gas stream received from the first separation unit.

18. The reactor system according to claim 15, further comprising:
an acid leaching unit configured to solubilize one or more active metal compounds from (i) a first portion of another spent carbon supported metal catalyst comprising one or more active metal compounds and solid carbon deposits received from the reactor and (ii) the spent carbon supported metal catalyst comprising the one or more active metal compounds and the solid carbon deposits received from the first separation unit with a leaching solution to generate a solubilized leaching solution comprising solubilized metal and a solid carbon product; wherein the solid carbon product is a high purity solid carbon product.

19. The reactor system according to claim 18, further comprising:
a fresh catalyst synthesis unit configured to contact the solubilized leaching solution with a second portion of the other spent carbon supported metal catalyst comprising the one or more active metal compounds and the solid carbon deposits and an aqueous solution stream comprising one or more other active metal compounds to generate a fresh carbon supported metal catalyst.

20. The reactor system according to claim 15, further comprising:
a first heat exchanger configured to heat the recycle stream comprising the unreacted light hydrocarbons and a light hydrocarbon feed stream using the product effluent comprising (i) the gas stream comprising the hydrogen and the unreacted light hydrocarbons and (ii) the spent carbon supported metal catalyst comprising the one or more active metal compounds and the solid carbon deposits to generate a first heated light hydrocarbon feed stream; and
a second heat exchanger configured to heat the first heated light hydrocarbon feed stream using another spent carbon supported metal catalyst comprising one or more active metal compounds and solid carbon deposits received from the reactor to generate a second heated combined light hydrocarbon feed stream.
